(19) United States
(12) Patent Application Publication
(10) Pub. No.: US 2026/0298442 A1
(43) Pub. Date: Oct. 1, 2026

(54) LIGHTING ARRANGEMENT

(71) Applicant: SIGNIFY HOLDING B.V., EINDHOVEN (NL)

(72) Inventors: ANNA WILHELMINA MARIA DE BEST, VELDHOVEN (NL); RENÉ BELTMAN, VUGHT (NL); MICHEL CORNELUS JOSEPHUS MARIA VISSENBERG, ROERMOND (NL); HENDRIKUS JOHAN ADRIE DE VRIES, VELDHOVEN (NL)

(21) Appl. No.: 19/481,121

(22) PCT Filed: Apr. 18, 2024
(86) PCT No.: PCT/EP2024/060516

§ 371 Date: Nov. 3, 2025

(30) Foreign Application Priority Data
May 4, 2023 (EP) 23171472.6
May 4, 2023 (EP) 23171493.2

(51) Int. Cl. F21V 11/02; F21S 8/04; F21V 5/00; F21V 13/02; F21Y 115/10

(52) U.S. Cl. CPC F21V 11/02; F21S 8/04; F21V 5/007; F21V 13/02; F21Y 2115/10

(57) ABSTRACT

A lighting arrangement comprises a cup comprising a wall that defines a light output opening and a plurality of LED light sources arranged inside the cup. The lighting arrangement further comprises a plurality of lenses, each lens being arranged adjacent to a respective LED light source and arranged to direct LED light emitted by respective LED light source through the light output opening of the cup. The plurality of lenses is arranged on a lens plate and a wall is arranged to protrude from the lens plate and arranged such that each lens is separated from each other lens by a section of the wall.

### FIELD OF THE INVENTION

The present invention generally relates to lighting arrangements. More specifically, the present invention is related to a lighting arrangement for providing downward overhead illumination and a luminaire comprising such a lighting arrangement.

### BACKGROUND OF THE INVENTION

Luminaires for lighting an environment such as an office should provide the right luminous flux and intensity distribution to give sufficient illuminance levels on the work plane (for example an average of 300 lux, with a uniformity of Eₘₐₓ/E_{average}<2). At the same time, the Unified Glare Rating (UGR) has to be below a specified target. In the United States UGR<22 is the norm, while in Europe the specification is often UGR<19.

In view of sustainability, but also in view of overall cost reduction, there is a strong desire to reduce energy consumption, and to reduce material use. Energy consumption can be reduced by either increasing the efficacy of the luminaire or by improving the efficiency of delivering task illuminance (i.e. bringing the light where it is needed). Material use and overall cost reduction can be achieved by reducing the number of luminaires that is needed to illuminate the environment, or in other words: by increasing the luminaire spacing in a room. Standard luminaire spacings range from 1.80 to 3.0 m in Europe, or 8 to 10 ft in the US, and are typically constrained by glare requirements, uniformity requirements, and task illuminance requirements.

Thus, for larger luminaire spacings, the luminous flux per luminaire must be increased in order to fulfil the work plane illuminance requirement. In addition, to reach uniformity requirements for larger luminaire spacings, each luminaire needs to have a wider beam to cover this larger area. However, both the higher flux and the wider beam have a negative effect on the glare perception and risk an unacceptable increase of the UGR. It has been found that prior art luminaires are unable to meet these illuminance, uniformity and UGR requirements for luminaire spacings over 3 meters.

### SUMMARY OF THE INVENTION

In view of the drawbacks associated with the prior art it is an object of the present invention to provide arrangements that can enable provision of a uniform high illuminance of an environment while at the same time enable a low UGR.

The object of the invention is achieved by a lighting arrangement for providing downward overhead illumination. The lighting arrangement comprises a cup comprising a wall that defines a light output opening and a plurality of LED light sources arranged inside the cup. The lighting arrangement further comprises a plurality of lenses, each lens being arranged adjacent to a respective LED light source and arranged to direct LED light emitted by respective LED light source through the light output opening of the cup. The plurality of lenses is arranged on a lens plate and a wall is arranged to protrude from the lens plate and arranged such that each lens is separated from each other lens by a section of the wall. The wall may have an optical property that causes a change in the direction of the LED light, by reflection, refraction, or scattering. The wall of the cup may be white and in various embodiments, the light output opening of the cup may have an outline that is in the shape of a circle, an ellipse, an oval, a polygon, a leaf shape, or a combination of any thereof.

The lens plate, the plurality of lenses and the wall may be one integral unit.

Each lens may protrude from the lens plate by a lens height and the wall may protrude from the lens plate by a maximum wall height, the maximum wall height being smaller than or equal to the lens height. Alternatively, the maximum wall height may be greater than or equal to the lens height.

The number of LEDs in said plurality of LED light sources may be between 2 and 9, the number of lenses in said plurality of lenses may be between 2 and 9, and the pitch between each LED may be 1 to 4 times a width of each LED.

In other words, the lighting arrangement may be provided with a cluster or array of LEDs. This is advantageous in situations where there are restrictions in LED positions due to string configurations. By arranging an additional optical element in the form of a wall between the lenses it is then possible to reduce any asymmetry in the cutoff of the visibility of the bright lenses and light up the area in between the lenses, and also reduce contrast between the lenses and thereby improving the viewer comfort.

At least one lens may be configured to direct the LED light according to at least one C-plane intensity profile. Each C-plane intensity profile comprises a main intensity peak in a first gamma, γ, angle interval between γ₁ and γ₂, where γ₂ is greater than γ₁ and each C-plane intensity profile comprises a secondary intensity shoulder or peak, at a lower intensity than the intensity of the main intensity peak, in a second γ angle interval between γ₃ and γ₄, where γ₃ is greater than γ₂, γ₄ is greater than γ₃ and γ₄ is less than or equal to 180°. The first γ angle interval may be between γ₁=0°, preferably 20°, more preferably 30° and γ₂=55°, preferably 50°, and the second γ angle interval may be between γ₃=60° and γ4=90°, preferably 80°. The wall of the cup may be white and in various embodiments, the light output opening of the cup may have an outline that is in the shape of a circle, an ellipse, an oval, a polygon, a leaf shape, or a combination of any thereof.

The lighting arrangement may be configured such that the LED light directed by the at least one lens in the first γ angle interval exits the light output opening of the cup without hitting the wall of the cup and that the LED light directed by the at least one lens in the second γ angle interval hits the wall of the cup before it exits the light output opening of the cup.

The at least one lens may comprise a base part and a top part, the top part being configured to direct the LED light in the first γ angle interval and the base part being configured to direct the LED light in the second γ angle interval.

Alternatively, the at least one lens may comprise a base part and a top part, the top part being configured to direct the LED light in the second γ angle interval and the base part being configured to direct the LED light in the first γ angle interval.

In other words, such a LED-based lighting arrangement provides peak intensities at γ angles between γ₁ and 2. For an observer located below the lighting arrangement, the visibility of the bright lens is cut off by the wall of the cup around the lens, resulting in that the LED (or the lens) is not visible at a γ angle that is greater than a cut-off angle. The value of the cut-off angle is dependent on the actual design of the lens and the cup and the placement of the LED and lens within the cup. The lens is designed such that the intensity of the bare lens increases or at least shows a discontinuity at γ angles greater than the cut-off angle resulting in a second (though smaller) intensity peak or intensity shoulder at γ angles between γ₃ and γ₄. The portion of light that is intercepted by the cup wall is re-emitted and adds a small Lambertian contribution to the total intensity distribution out of the lighting arrangement. This makes the luminance of the cup wall high enough so that the whole surface area of the cup can be taken into account in the UGR calculations specified by the International Commission on Illumination (CIE) and thereby contribute to a low UGR. It is to be noted that, by using commercially available optical engineering software tools such as “Light Tools” it is possible to design lens and cup parameters and relationships that result in the desired intensity profiles.

The object of the invention is achieved by a luminaire comprising a plurality of lighting arrangements as summarized above, having effects and advantages as summarized above.

### BRIEF DESCRIPTION OF THE DRAWINGS

This and other aspects of the present invention will now be described in more detail, with reference to the appended drawings showing embodiment(s) of the invention.

FIG. 1a schematically illustrates a perspective view of lighting arrangements that form part of a luminaire,

FIG. 1b schematically illustrates a cross-sectional view of a lighting arrangement having one LED and one lens,

FIG. 1c schematically illustrates intensity profiles,

FIG. 1d schematically illustrates a side view of a lens,

FIG. 2a schematically illustrates a cross-sectional view of a lighting arrangement having a plurality of LEDs and lenses,

FIG. 2b is a detailed view of the lighting arrangement schematically illustrated in FIG. 2a,

FIGS. 2c and 2d schematically illustrate a respective perspective view of a lighting arrangement having a plurality of LEDs and lenses, and

FIG. 3 schematically illustrates a side view of luminaires providing downward overhead illumination.

### DETAILED DESCRIPTION

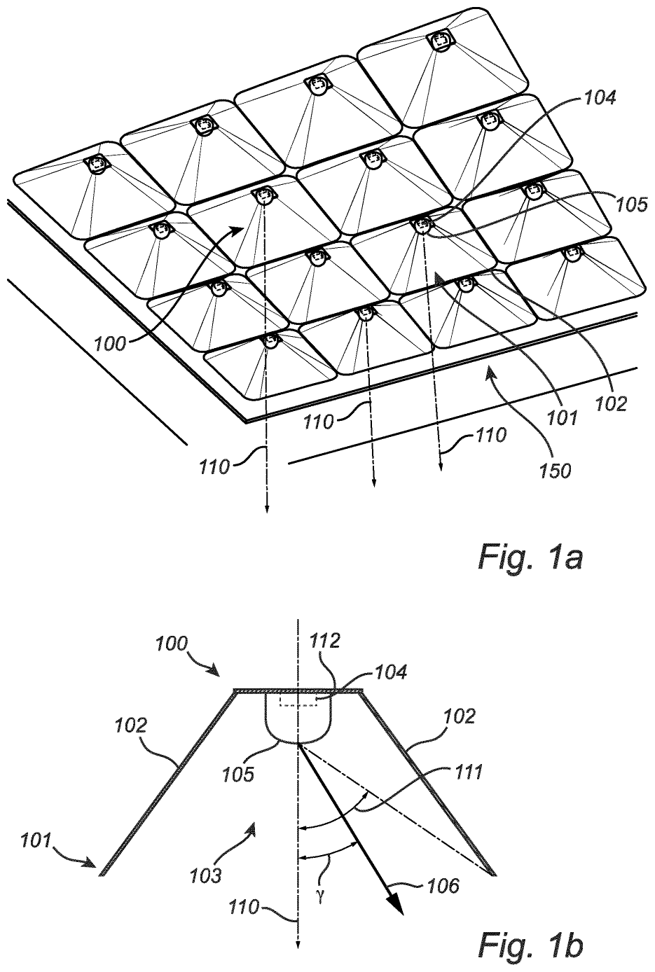

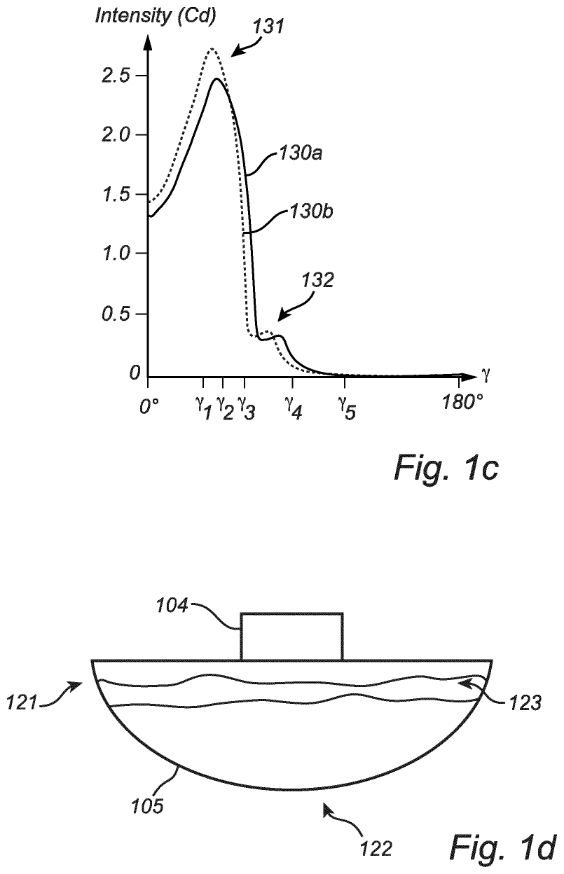

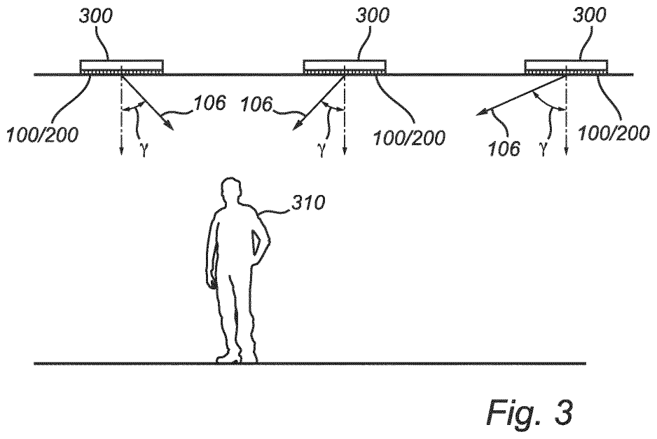

Referring to FIGS. 1a-d and to FIG. 3, a lighting arrangement 100 for providing downward overhead illumination comprises a cup 101 comprising a wall 102 that defines a light output opening 103. At least one LED light source 104 is arranged on a printed circuit board (PCB) inside the cup 101 and at least one lens 105 arranged adjacent to the LED light source 104 and arranged to direct LED light 106 emitted by the LED light source 104 through the light output opening 103 of the cup 101.

The at least one lens 105 is configured to direct the LED light 106 according to at least one C-plane intensity profile 130a, 130b. Two such intensity profiles 130a, 130b are exemplified in the diagram in FIG. 1c. Each C-plane intensity profile 130a, 130b comprises a main intensity peak 131 in a first gamma, γ, angle interval between γ₁ and γ₂, where γ₂ is greater than γ₁. Each C-plane intensity profile 130a, 130b comprises a secondary intensity shoulder or peak 132, at a lower intensity than the intensity of the main intensity peak 131, in a second γ angle interval between γ₃ and γ₄, where γ₃ is greater than γ₂, γ₄ is greater than γ₃ and γ₄ is less than or equal to 180°.

As illustrated in FIGS. 1a and 1b, the γ angle is the angle of LED light emission out of the lens 105 in relation to a main direction of light 110, which in the context herein is the downward direction. The γ angle may have values between 0° and 180°. A C-plane is defined such that the main direction of light 110 lies in the C-plane and the C-plane may have an angle of rotation of 0° to 360° around the main direction of light 110.

The LED light 106 directed by the at least one lens 105 in the first γ angle interval exits the light output opening 103 of the cup 101 without hitting the wall 102 of the cup 101. The LED light 106 directed by the at least one lens 105 in the second γ angle interval hits the wall 102 of the cup 101 before it exits the light output opening 103 of the cup 101. In FIG. 1b, this is illustrated by a cut-off γ angle 111.

The first γ angle interval is between γ₁=0°, preferably 20°, more preferably 30° and γ₂=55°, preferably 50° and the second γ angle interval is between γ₃=60° and γ₄=90°, preferably 80°.

FIG. 1d illustrates that the at least one lens 105 may comprise a base part 121 and a top part 122. The top part 122 is configured to direct the LED light 106, emitted by the LED 104, in the first γ angle interval and the base part 121 is configured to direct the LED light 106 in the second γ angle interval. An area 123 indicates an area of the surface of the base part 121 where most light is directed in the second gamma interval.

It is to be noted that the base part 121 and the top part 122 may partly overlap such that less than 100% of the light passing through one part may end up in the corresponding gamma interval.

In fact, by configuring the at least one lens 105 with total internal reflection (TIR), it also possible to obtain a top part 122 that directs light in the second γ angle interval and a base part 122 that directs light in the first γ angle interval. In such a design the rays traversing the base part 121 and the rays traversing the top part 122 will cross. That is, in such a configuration the top part 122 is configured to direct the LED light 106 in the second γ angle interval and the base part 121 is configured to direct the LED light 106 in the first γ angle interval.

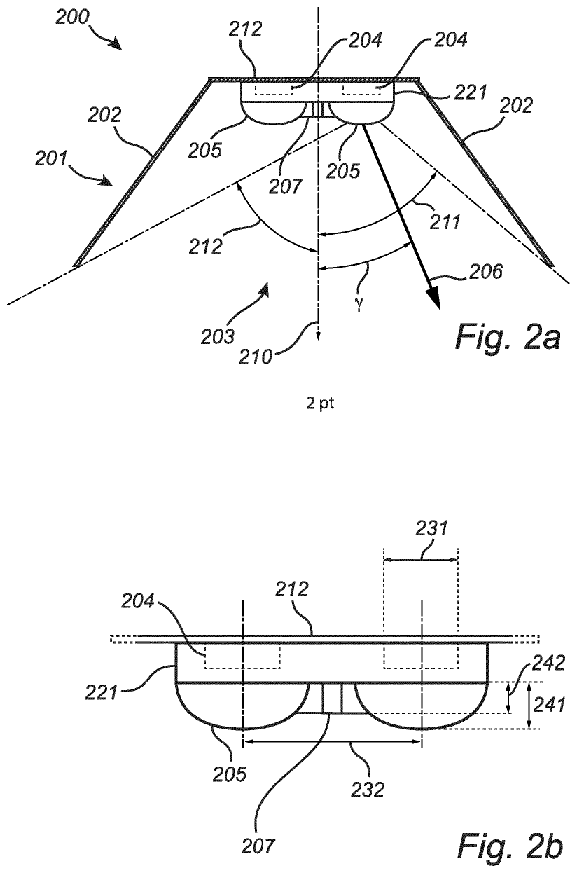

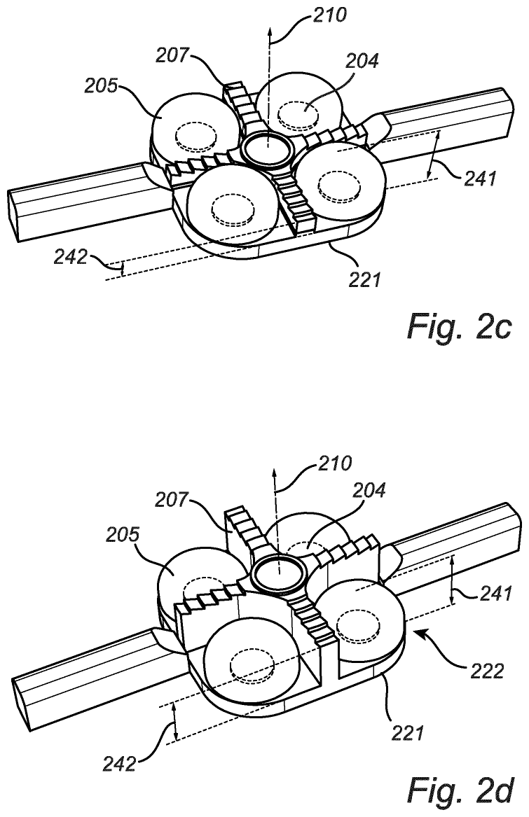

Referring now also to FIGS. 2a-d, a lighting arrangement 200 for providing downward overhead illumination may comprise a cup 201 comprising a wall 202 that defines a light output opening 203 and a plurality of LED light sources 204 are arranged on a printed circuit board (PCB) 212 inside the cup 201. The lighting arrangement 200 further comprises a plurality of lenses 205, each lens 205 being arranged adjacent to a respective LED light source 204 and arranged to direct LED light 206 emitted by respective LED light source 204 through the light output opening 203 of the cup 201. The plurality of lenses 205 is arranged on a lens plate 221 and a wall 207 is arranged to protrude from the lens plate 221 and arranged such that each lens 205 is separated from each other lens 205 by a section of the wall 207.

The wall 207 has an optical property that causes a change in the direction of the LED light 206, by reflection, refraction, or scattering.

FIG. 2a illustrates two cut-off γ angles 211, 212 with respect to different parts of the cup wall 202, exemplifying that the wall 207 will intercept LED light 206 emitted via lenses 205 located at different distances from the cup wall 202 along different γ angles for different parts of the cup wall 202 and thereby preventing a direct view of a lens 205, as viewed by a viewer 310.

As illustrated in the detailed view of the lighting arrangement 200 in FIG. 2b, each lens 205 protrudes from the lens plate 221 by a lens height 241 and the wall 207 protrudes from the lens plate 221 by a maximum wall height 242.

As illustrated in FIG. 2c, the maximum wall height 242 may be smaller than or equal to the lens height 241 and, as illustrated in FIG. 2d, the maximum wall height 242 may be greater than or equal to the lens height 241.

The wall 207 shown in FIGS. 2c and 2d has a varying height. In particular, the wall 207 has a top side that is provided with a plurality of projections or protrusions.

In the example of FIGS. 2c and 2d, the wall 207 has a top side that is provided with a sawtooth profile, being an example of a serrated (or toothed) profile. A sawtooth profile is a non-sinusoidal profile that is characterized by a linear, rising edge and a sudden drop-off, and that repeats itself periodically.

As said, the sawtooth profile of the wall 207 as shown in FIGS. 2c and 2d is an example of a serrated profile, the latter in turn being an example of a plurality of projections or protrusions. Other pluralities of projections or protrusions may be used instead, for example other serrated profiles, such as any non-sinusoidal profile or sinusoidal profile, whether regular or irregular. As mentioned above, the wall 207 is arranged to intercept LED light 206 emitted via lenses 205 located at different distances from the cup wall 202 along different γ angles for different parts of the cup wall 202. Thereby, the wall 207 is arranged to prevent a direct view of a lens 205.

The wall 207 may be made from the same material as the lenses 205, in which case the wall 207 will be made from an optically clear material, i.e., a material that absorbs, reflects, and scatters little or no light. Such a material may also be referred to as a transparent material.

When the wall 207 is made from a material that absorbs, reflects, and scatters little or no light, the direct view of the lens 205 can for example be obscured by scattering via surface textures, although this may only have a limited effect.

Alternatively, the direct view of the lens 205 can be obscured by means of surface structures, which may have a stronger effect, particularly if such surface structures give rise to total internation reflection (TIR) effects.

When the wall 207 is positioned relatively close to the lenses 205, there may not be sufficient space to provide the side surfaces of the wall 207 (i.e., the surfaces facing the lenses 205) with light deflecting structures. In such a situation, the top side of the wall 207 would still be available for providing the desired light deflecting structures in the form of surface structures, such as surface structures that are arranged to deflect light by means of TIR effects.

By providing the top side of the wall 207 with a plurality of projections or protrusions, for example in the form of a serrated (or toothed) profile, such as the sawtooth profile shown in FIGS. 2c and 2d, the wall 207 is arranged to obscure a direct view of the lenses 205 by means of scattering via surface structures. When the wall 207 would additionally be made from an optically clear material, the surface structures formed by the plurality of projections or protrusions may give rise to TIR effects to thereby further improve the ability to obscure a direct view of the lenses 205.

The wall 207 may have a thickness that is such (for example, a thickness in a range of 0.5 to 5 millimeters, such as in a range of 1 to 3 millimeters) that only a small part of the light rays (those entering the side surface of the wall 207 at a specific incoming angle and specific height) reach the top side, where they would then undergo a change of direction.

A further advantage of the wall 207 having a top side that is provided with a plurality of projections or protrusions is that a larger range of incoming angles and positions of light rays incident on a side surface side of the wall 207 may reach the top side to The plurality of projections or protrusions provided at the top side of the wall 207 has an amplitude and a spacing, the amplitude being the height of the projections or protrusions (which may be an average height in case the projections or protrusions have a non-constant height), and the spacing being the distance between adjacent projections or protrusions (which may be an average spacing in case the projections or protrusions are separated by non-constant distances).

The amplitude and/or the spacing of the plurality of projections or protrusions is preferably smaller than the dimensions of the lenses 205, such as in the order of 5 to 50% of the dimensions of the lenses 205.

As exemplified in the perspective view in FIG. 2d, the lens plate 221, the plurality of lenses 205 and the wall 207 may be one integral unit 222, whereas FIG. 2c exemplifies a configuration where the lenses 205 and the wall 207 are separate entities that are arranged on the lens plate 221.

FIG. 2c and FIG. 2d exemplifies lighting arrangements with four lenses 205 and corresponding four LEDs 204. However, in other embodiments the number of LEDs 204 in the plurality of LED light sources 204 may be between 2 and 9 and the number of lenses 205 in the plurality of lenses 205 may be between 2 and 9 and, as illustrated in FIG. 2b, the pitch 232 between each LED 204 may be 1 to 4 times a width 231 of each LED 204. Similar to the embodiments of a lighting arrangement 100 described in connection with FIGS. 1a-d, in the lighting arrangement 200 exemplified in FIGS. 2a-d at least one lens 205 may be configured to direct the LED light 206 according to at least one C-plane intensity profile 130a, 130b, as illustrated in FIG. 1c. Each C-plane intensity profile 130a, 130b comprises a main intensity peak 131 in a first gamma, γ, angle interval between γ₁ and γ₂, where γ₂ is greater than γ₁ and each C-plane intensity profile 130a, 130b comprises a secondary intensity shoulder or peak 132, at a lower intensity than the intensity of the main intensity peak 131, in a second γ angle interval between γ₃ and 14, where γ₃ is greater than γ₂, γ₄ is greater than γ₃ and γ₄ is less than or equal to 180°.

The LED light 206 directed by the at least one lens 205 in the first γ angle interval exits the light output opening 203 of the cup 201 without hitting the wall 202 of the cup 201. The LED light 206 directed by the at least one lens 205 in the second γ angle interval hits the wall 202 of the cup 201 before it exits the light output opening 203 of the cup 201. In FIG. 2a, this is illustrated by a cut-off γ angle 211.

The first γ angle interval is between γ₁=0°, preferably 20°, more preferably 30° and γ₂=55°, preferably 50° and the second γ angle interval is between γ₃=60° and γ₄=90°, preferably 80°.

The at least one lens 205 may correspond to the lens 105 illustrated in FIG. 1d and, as such, it may comprise a base part 121 and a top part 122. The top part 122 is configured to direct the LED light 106, emitted by the LED 104, in the first γ angle interval and the base part 121 is configured to direct the LED light 106 in the second γ angle interval. An area 123 indicates an area of the surface of the base part 121 where most light is directed in the second gamma interval.

It is to be noted that the base part 121 and the top part 122 may partly overlap such that less than 100% of the light passing through one part may end up in the corresponding gamma interval.

In fact, by configuring the at least one lens 105 with total internal reflection (TIR), it also possible to obtain a top part 122 that directs light in the second γ angle interval and a base part 122 that directs light in the first γ angle interval. In such a design the rays traversing the base part 121 and the rays traversing the top part 122 will cross. That is, in such a configuration the top part 122 is configured to direct the LED light 106 in the second γ angle interval and the base part 121 is configured to direct the LED light 106 in the first γ angle interval.

The lighting arrangement 100, 200 exemplified above may have a cup 101, 201 having a wall 102, 202 that is white. Moreover, the light output opening 103, 203 of the cup 101, 201 may have an outline that is in the shape of a circle, an ellipse, an oval, a polygon, a leaf shape, or a combination of any thereof.

As illustrated in FIG. 3, and as illustrated in FIG. 1a, a luminaire 150, 300 may comprise a plurality of lighting arrangements 100, 200 as described above.

1. A lighting arrangement for providing downward overhead illumination, comprising:
a cup comprising a wall that defines a light output opening
a plurality of light emitting diode, LED, light sources arranged inside the cup,
a plurality of lenses, each lens being arranged adjacent to a respective LED light source and arranged to direct LED light emitted by respective LED light source through the light output opening of the cup,
a lens plate on which the plurality of lenses is arranged,
a wall arranged to protrude from the lens plate and arranged such that each lens is separated from each other lens by a section of the wall,
wherein the wall has an optical property that causes a change in the direction of the LED light, by reflection, refraction, or scattering, and
wherein the wall has a top side that is provided with a plurality of projections or protrusions.

2. The lighting arrangement according to claim 1, wherein the plurality of projections or protrusions form a serrated profile.

3. The lighting arrangement according to claim 1, wherein the plurality of projections or protrusions provided at the top side of the wall has an amplitude and a spacing, and wherein the amplitude and/or the spacing is smaller than the dimensions of the lenses.

4. The lighting arrangement according to claim 1, wherein:
each lens protrudes from the lens plate by a lens height,
the wall protrudes from the lens plate by a maximum wall height,
the maximum wall height is smaller than or equal to the lens height.

5. The lighting arrangement according to claim 1, wherein:
each lens protrudes from the lens plate by a lens height,
the wall protrudes from the lens plate by a maximum wall height,
the maximum wall height is greater than or equal to the lens height.

6. The lighting arrangement according to claim 1, wherein:
the lens plate, the plurality of lenses and the wall are one integral unit.

7. The lighting arrangement according to claim 1, wherein:
the number of LEDs in said plurality of LED light sources is between 2 and 9,
the number of lenses in said plurality of lenses is between 2 and 9, and
the pitch between each LED is 1 to 4 times a width of each LED.

8. The lighting arrangement according to claim 1, wherein:
at least one lens is configured to direct the LED light according to at least one C-plane intensity profile,
each C-plane intensity profile comprises a main intensity peak in a first gamma, g, angle interval between g₁ and g₂, where g₂ is greater than g₁,
each C-plane intensity profile comprises a secondary intensity shoulder or peak, at a lower intensity than the intensity of the main intensity peak in a second g angle interval between g₃ and g₄, where g₃ is greater than g₂, g₄ is greater than g₃ and g₄ is less than or equal to 180°.

9. The lighting arrangement according to claim 8, configured such that:
the LED light directed by the at least one lens in the first g angle interval exits the light output opening of the cup without hitting the wall of the cup, and
the LED light directed by the at least one lens in the second g angle interval hits the wall of the cup before it exits the light output opening of the cup.

10. The lighting arrangement according to claim 8, wherein:
the at least one lens comprises a base part and a top part,
the top part is configured to direct the LED light in the first g angle interval, and
the base part is configured to direct the LED light in the second g angle interval.

11. The lighting arrangement according to claim 8, wherein:
the at least one lens comprises a base part and a top part,
the top part is configured to direct the LED light in the second g angle interval, and
the base part is configured to direct the LED light the first g angle interval.

12. The lighting arrangement according to claim 8, wherein:
the first g angle interval is between g₁=0° and g₂=55°, and
the second g angle interval is between g₃=60° and g₄=90°.

13. The lighting arrangement according to claim 1, wherein:
the wall of the cup is white.

14. The lighting arrangement according to claim 1, wherein the light output opening of the cup has an outline that is in the shape of:
a circle, an ellipse, an oval,
a polygon,
a leaf shape, or
a combination of any thereof.

15. A luminaire comprising a plurality of lighting arrangements according to claim 1.
